(19) United States
(12) Patent Application Publication
(10) Pub. No.: US 2015/0040584 A1
(43) Pub. Date: Feb. 12, 2015

(54) DRIVER FOR THERMO-ELECTRIC COOLER

(71) Applicant: SUMITOMO ELECTRIC DEVICE INNOVATIONS, INC., Yokohama-shi (JP)

(72) Inventor: Ryutaro TAKEI, Yokohama-shi (JP)

(21) Appl. No.: 14/453,030

(22) Filed: Aug. 6, 2014

(30) Foreign Application Priority Data
Aug. 7, 2013 (JP) P2013-164232

(51) Int. Cl. F25B 21/04; G05D 23/19

(52) U.S. Cl. CPC F25B 21/04; G05D 23/1919
USPC 62/3.7

(57) ABSTRACT

A TEC-driver that saves the power consumption is disclosed. The TEC-driver includes the H-bridge to supply the driving current to the TEC in the analog mode. The power supply voltage for the H-bridge is dynamically varied as following the voltage applied to the TEC to set the high side transistor in the H-bridge under the minimum bias condition necessary for the stable operation.

### BACKGROUND OF THE INVENTION

1. Field of the Invention

The present application relates to a driver for thermo-electric cooler (thereafter denoted as TEC), in particular, the application relates to a TEC-driver saving power dissipation thereof.

2. Related Background Art

A TEC is a device to choose one of two modes, namely, cooling down or heating up a temperature of one of two plates provided in the TEC by setting a direction of a current supplied to the TEC. Conventionally, two methods have been known in the field to change the direction of the driving current. One is that the TEC in one electrode thereof is grounded and the other electrode is driven in bipolar by positive and negative power supplies. The other is that the TEC is involved within, what is called an H-bridge powered by a signal power supply and the direction of the driving current is switched by turning on/off two transistors diagonally connected in the H-bridge. Either method is necessary to adjust the magnitude of the driving current.

Popular technique to adjust the magnitude of the driving current is to use the pulse width modulation (PWM). The PWM control may adjust the magnitude of the driving current by intermittently supplying the current, that is, to adjust a period of the current flowing against a period of the current blocking, which is often called as the duty ratio. In the PWM method, the current is provided to the TEC through an inductor and a capacitor constituting a low-pass filter. The pulsed current is provided to the TEC after converted in a DC current by the low-pass filter.

The PWM control inevitably accompanies with a ripple derived from the pulse current. Recent request to control the temperature of the TEC extremely in precise, for instance, a TEC used in the dense wavelength division multiplexing (DWDM) system with a grid span of 50 GHz, the ripple appearing in the driving current causes a fluctuation of the emission wavelength. Also, the PWM control turns on/off a large current in the first place, and the switching of the large current causes the electro-magnetic interference (EMI) noise, which sometimes degrades the sensitivity of the optical receiver. Another method to drive a TEC in analog has also been known in the field. For instance, a United State Patent application published as US 2012/161818A has disclosed a technique to drive a TEC an analogue. However, a TEC-driver disclosed therein does not have a. mode where at least one transistor constituting the H-bridge wholly turns off. That is, a leak current always flows in the H-bridge in addition to the current flowing from the one side to the other as intersecting the TEC.

### SUMMARY OF THE INVENTION

An aspect of the present application relates to a driver to drive TEC in the analog mode. The driver of embodiments of the present application provides an H-bridge and a power supply to bias the H-bridge, The H-bridge includes a series circuit of a first transistor and a third transistors, and another series circuit of a second transistor and a fourth transistors. The series circuit generates a first output between the first and third transistors, while, the another series circuit generates a second output between the second and fourth transistors. The TEC is connected between the first and second outputs. A feature of the driver is that the bias generated by the power supply and provided to the H-bridge is determined by one of the first output and the second output greater than the other. Because the bias supplied to the H-bridge is set as minimum as the first and second transistors may operate in the saturation mode, or may be linearly operable for the inputs thereof, which may save the power consumption of the driver.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 shows a circuit diagram of a TEC-driver according to an embodiment of the invention;

FIG. 2 extracts a circuit for the positive operation from the H-bridge shown in FIG. 1;

FIG. 3 extracts a circuit for the negative operation from the H-bridge shown in FIG. 1;

FIG. 4 shows a relation of the sensing signal Vₛ and the outputs, Vₒ₊ and Vₒ₋, for the positive and negative operations, respectively;

FIGS. 5A and 5B show examples of the power supply implemented with the TEC-driver shown in FIG. 1;

FIG. 6 shows relations of the power supply voltage, the detected levels of the outputs in the power supply shown in FIGS. 5A and 5B against the sensing signal;

FIGS. 7A and 7B show another examples of the power supply implemented within the TEC-driver shown in FIG. 1; and

FIG. 8 shows relations of the power supply voltage and the detected levels of the outputs in the power supply shown in FIGS. 7A and 7B against the sensing signal.

### DESCRIPTION OF THE PREFERRED EMBODIMENTS

Next, some embodiments of a TEC driver according to the present invention will be described as referring to drawings. In the description of the drawings, same numerals or symbols same with or similar to each other will refer to elements same with or similar to each other without duplicating explanations.

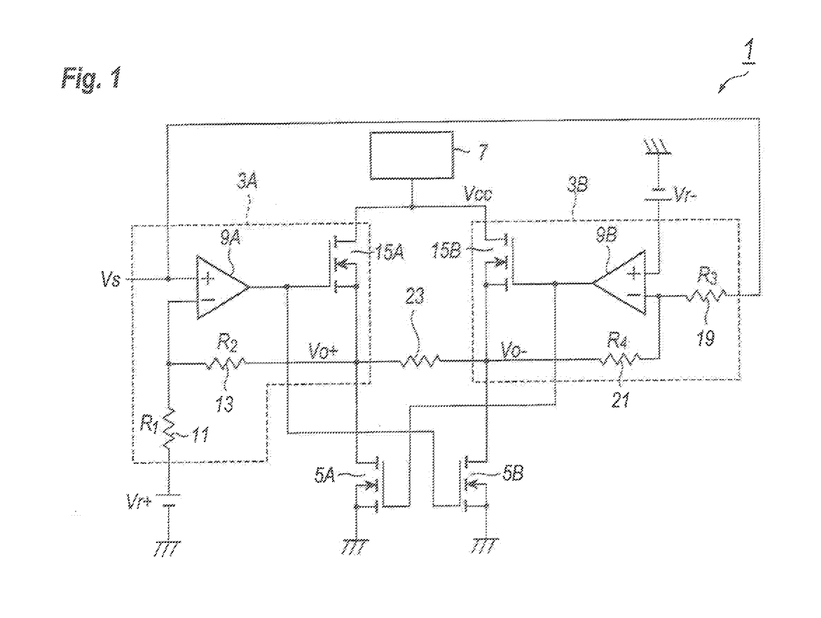

FIG. 1 is a circuit diagram of a TEC-deriver 1 according to an embodiment of the present invention. The TEC-driver 1 controls the driving current supplied to the TEC, exactly magnitude and direction thereof, based on a sensing signal Vₛ output from a temperature sensor, which is typically a thermistor. The TEC-driver 1 includes a differential amplifier 3A to amplify the sensing signal Vₛ in the non-inverting arrangement, another differential amplifier 3B also to amplify the sensing signal Vₛ but in the inverting arrangement, two field effect transistors (FET), 5A and 5B, each provided between respective outputs of the respective differential amplifiers, 3A and 3B, and the ground, and a power supply 7 to bias the differential amplifiers, 3A and 3B.

The differential amplifier 3A in the non-inverting arrangement includes an operational amplifier 9A, resistors, 11 and 13, and an FET 15A connected in the output of the operational amplifier 9A. Two resistors, 11 and 13, have the resistance, R₁ and R₂, respectively. The operational amplifier 9A receives the sensing signal Vₛ in the non-inverting input thereof, and a positive reference Vᵣ₊ in the inverting input through the resistor R₁₁. The output of the operational amplifier 9A is fed-back to the inverting input thereof through the FET 15A and the resistor 13. Thus, the differential amplifier 3A amplifies a difference between the sensing signal Vₛ and the positive reference Vᵣ₊ in the non-inverting arrangement. In other words, the differential amplifier 3A varies an output Vₒ₊ thereof such that the non-inverting input of the operational amplifier 9A becomes substantially equal to the sensing signal Vₛ. The inverting input of the operational amplifier 9A may be determined by the output Vₒ₊ of the differential amplifier 3A and the positive reference Vᵣ₊. The FET 15A, which is an n-type MOSFET in the present embodiment, operates as a current buffer of the operational amplifier 9A.

The differential amplifier 3B includes another operational amplifier 9B, two resistors, 19 and 21, and an FET 15B. The operational amplifier 9B receives the sensing signal Vₛ in the inverting input thereof through the resistor 19, while, a negative reference Vᵣ₋ directly in the non-inverting input. The output of the operational amplifier 9B is fed-back to the inverting input thereof through the FET 15B and the resistor 21. Thus, the differential amplifier 3B amplifies a difference between the sensing signal Vₛ and the negative reference Vᵣ₋ in the inverting arrangement. In other words, the operational amplifier 9B varies the output thereof such that the inverting input thereof becomes substantially equal to the negative reference Vᵣ₋. The non-inverting input of the operational amplifier 9B may be determined by the output Vₒ₋ thereof and the sensing signal Vₛ. The FET 15B, which is also an n-type MOSFET in the present embodiment, operates as a current buffer for the operational amplifier 9B.

The TEC 23, which is equivalently denoted as a resistor, is put between two outputs, Vₒ₊ and Vₒ₋, of the differential amplifiers, 3A and 3B. Moreover, respective outputs of the differential amplifiers, 3A and 3B, are grounded through the FETs, 5A and 5B. Specifically, the FET 5A is connected in the drain thereof to the output of the differential amplifier 3A, in the gate thereof to the output of the operational amplifier 9B, and grounded in the source thereof. Thus, the FET 5A and the FET 15B are commonly driven by the operational amplifier 9B. The FET 5B is connected in the drain thereof to the output of the differential amplifier 3B, in the gate thereof to the output of the operational amplifier 9A, and grounded in the source thereof. The FET 5B and the FET 15A are commonly driven by the operational amplifier 9A.

The differential amplifiers, 3A and 3B, and two FETS, 5A and 5B, constitute, what is called, an H-bridge that drivers the TEC linearly not digitally. In the H-bridge, the sensing signal Vₛ is commonly provided to two operational amplifiers, 9A and 9B, and the former operational amplifier 9A operates when the sensing signal Vₛ deviates positively with respect to the positive reference Vᵣ₊; while, the other operational amplifier 9B operates when the sensing signal Vₛ deviates negatively to the negative reference Vᵣ₋. In the former mode when the sensing single Vₛ deviates positively, two outputs show a relation of Vₒ₊>Vₒ₋, that is, the TEC current flows from the output of the differential amplifier 3A to the output of the differential amplifier 3B. Oppositely, when the sensing signal Vₛ shifts negatively; the TEC current flows to the differential amplifier 3A from the other differential amplifier 3B. Next, the operation of the H-bridge will be described in detail.

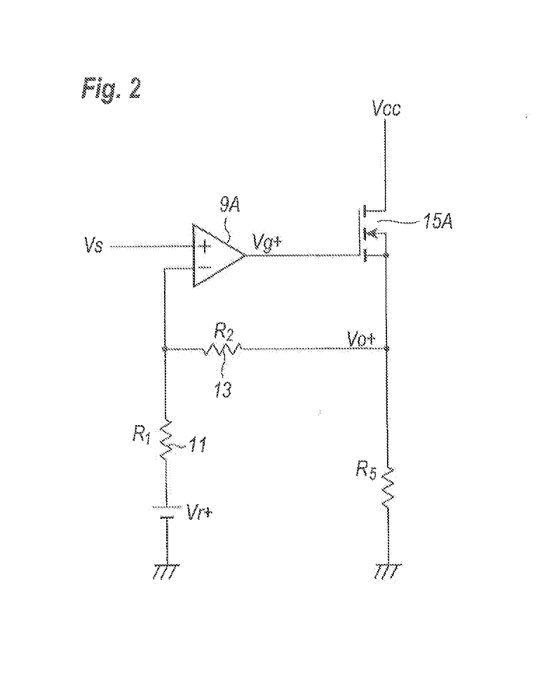

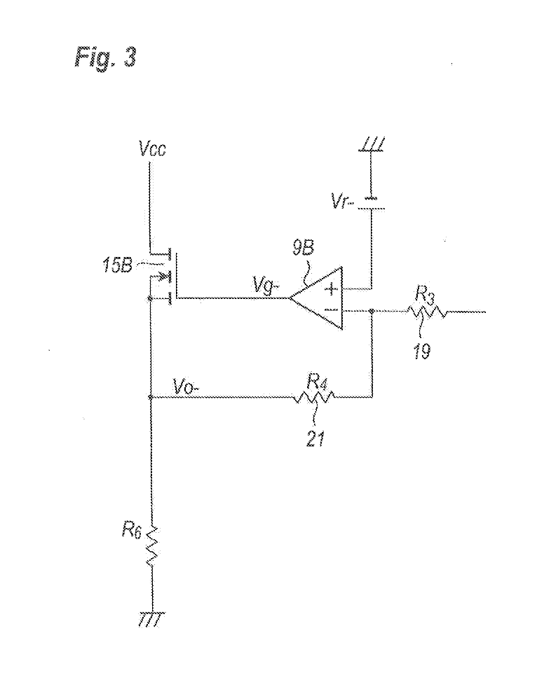

FIG. 2 extracts circuit elements of the H-bridge when the sensing signal Vₛ shifts positively, while, FIG. 3 extracts circuit elements when the sensing signal Vₛ shifts negatively. From the relation that an operational amplifier operates so as to set two inputs thereof in an imaginary short circuit; the following two equations may be derived:

Vₛ=Vᵣ₊+(Vₒ₊−Vᵣ₊)×R₁/(R₁+R₂), accordingly, Vₒ₊=(1+R₂/R₁)×Vₛ−(R₂/R₁)×Vᵣ₊. (1)

Vᵣ₋=Vₒ₋+(Vₛ−Vₒ₋)×R₄/(R₃+R₄), accordingly, Vₒ₋=−(R₄/R₃)×Vₛ+(1+R₄/R₃)×Vᵣ₋. (2)

The H-bridge sets the resistance of the resistors, R₁ to R₄, to follow the relation below:

(1+R₂/R₁)=(R₄/R₃)=A,

in order to stabilize the operation by equating the positive gain for the operational amplifier 9A with the negative gain for the other operational amplifier 9B, where the equalized gain is denoted by A.

Rewriting equations (1) and (2) by the gain A, the flowing two equations, (3) and (4), may be derived:

Vₒ₊=A×Vₛ+(1−A)×Vᵣ₊, (3)

and

Vₒ₋=−A×Vₛ+(1+A)×Vᵣ₋. (4)

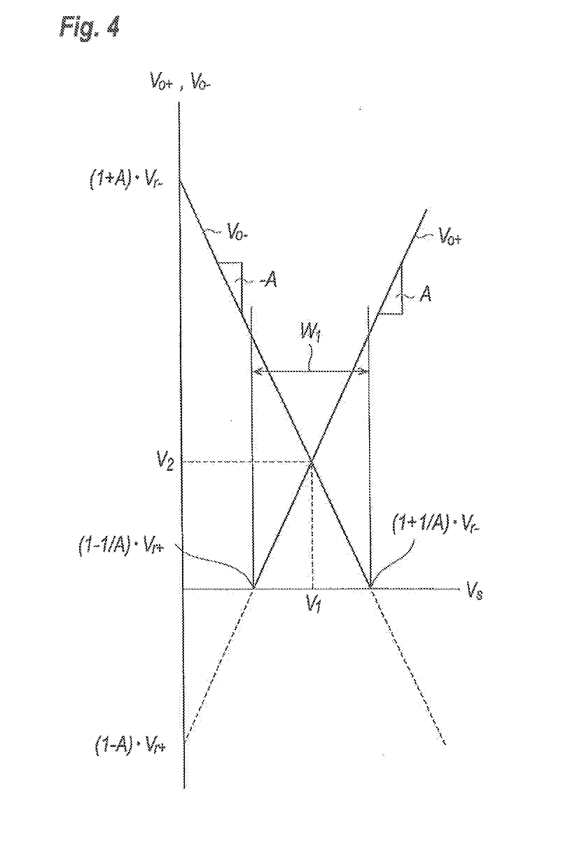

From equations above, the relation between the sensing signal Vₛ and two outputs, Vₒ₊ Vₒ₋, are schematically illustrated as that shown in FIG. 4. The positive output Vₒ₊ monotonically and linearly increases with a slope A as the sensing signal Vₛ increases. When the sensing signal Vₛ is equal to zero (0), the positive output becomes (1−A)·Vᵣ₊. While, the negative output Vₒ. monotonically and linearly decreases with a slope −A as the sensing signal Vₛ increases and becomes (1+A)·Vᵣ₋ when the sensing signal Vₛ is zero (0). Moreover, when the sensing signal Vₛ becomes V₁, where V₁ is calculated as:

V₁=(Rᵣ₋−Vᵣ₊)/(2A)+(Vᵣ₊+Vᵣ₋(/2,

two outputs, Vₒ₊ and Vₒ₋, coincide with each other at V₂, where V₂ is:

V₂=−A·(Vᵣ₊−Vᵣ₋)/2+(Vᵣ₊+Vᵣ₋)/2.

Further analyzing a case where two outputs, Vₒ₊ and Vₒ₋, coincide to the other, the second member of the sensing signal Vₛ (V₁) and the second member of two outputs V₂ (Vₒ₊ and Vₒ₋), are an average of two references, Vᵣ₊ and Vᵣ₋, while respective first members are corrections for the average appearing in the second member.

When two references, Vᵣ₊ and Vᵣ₋, are set to be equal to the other (Vᵣ₊=Vᵣ₋=Vᵣ), two outputs, Vₒ₊ and Vₒ₋, become the same level at a case where the sensing signal Vₛ is equal to the reference Vᵣ. In such a case, no driving current flows in the TEC 23. When the sensing signal Vₛ exceeds the reference Vᵣ, the positive driving current flows in the TEC 23 from the positive output Vₒ₊ to the negating output Vₒ₋. Oppositely, the negative driving current flows in the TEC 23 from the negative output Vₒ₋ to the positive output Vₒ₊, when the sensing signal Vₛ becomes less than the reference Yᵣ.

Next, further practical case of the H-bridge will be described where the low side FETS, 5A and 5B, which are assumed to be respective pure resistors having the resistance, R₅ and R₆, in the aforementioned analysis, are operable as an active device. Two outputs, Vₒ₊ and Vₒ₋, becomes zero when the sensing signal Vₛ takes (1−1/A)·Vᵣ and (1+1/A)·Vᵣ, respectively. When the sensing signal Vₛ exceeds (1+1/A)·Vᵣ, the low side FET 5B fully turns on to cramp the drain thereof in the ground because an enough positive bias is applied to the gate thereof. That is, the negative output Vₒ₋ is virtually grounded and the FET 15A is grounded in the source thereof through the TEC 23.

On the other hand, when the sensing signal Vₛ becomes less than (1−1/A)·Vᵣ, the FET 5A fully turns on to cramp the drain thereof in the ground because an enough positive bias is applied to the gate. That is, the positive output Vₒ₊ is virtually grounded and the FET 15B is grounded in the source thereof through the TEC 23.

When the sensing signal Vₛ is in an intermediate range W₁, namely, from (1−1/A)·Vᵣ<Vₛ<(1+/A)·Vᵣ, the H-bridge performs the analog operation. That is, in the medium range W₁, the FETs, 15A and 15B, become active to flow the driving current therein, so do the low side FETs, 5A and 5B. The magnitude and the direction of the driving current may be determined by the gate biases. The width of the intermediate range W₁ depends on the gain A of the operational amplifiers, 9A and 9B, exactly, the ratio of the resistance, R₃/R₄ and R₁/R₂. The larger the gain A, the narrower the width of the intermediate range W₁, while, the width W₁ expands as the gain A decreases.

Thus, the H-bridge in the TEC-driver shown in FIG. 1 may perform the analog operation for the sensing signal Vₛ, the input signal, around the reference revel Vᵣ. Under the analog operation, the driving current flows in both branch of the H-bridge different from the conventional mode where two FETs diagonally connected in the H-bridge fully turn off. The analog operation, as described above, inevitably causes an idle current that bypasses the TEC, not flowing in the TEC, which increases the power consumption the driver.

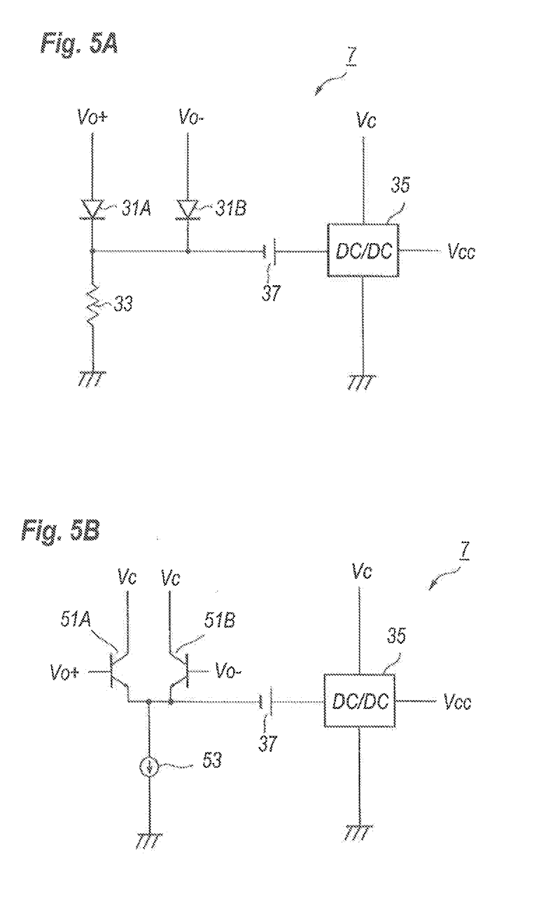

The TEC-driver of the present invention provides the power supply 7 to supply the power VCC to two differential amplifiers. FIG. 5A shows an example of a circuit diagram of the power supply 7. The power supply 7 in FIG. 5A provides two diodes, 31A and 31B, whose anodes are connected to the outputs, Vₒ₊ and Vₒ₋, respectively, and cathodes thereof are commonly connected to a resistor 33; a DC-to-DC converter 35; and a voltage source 37 connected between the DC/DC converter 35 and the common cathode of two diodes, 31A and 31B.

Two diodes, 31A and 31B, and the resistor 33 detect one of the outputs, Vₒ₊ or Vₒ₋, having greater level. The detected greater level is reflected in the common cathode. The DC/DC converter 35 generates the power supply voltage VCC from the source VC higher by the constant voltage 37. The power supply voltage VCC thus generates is provided to the H-bridge. FIG. 5B is a modification of the circuit 7, where the circuit includes a pair of transistors, 51A and 51B, and a current source 53, substituted from two diodes, 31A and 31B, and the resistor 33. The substituted circuit is operable as a peak detector that outputs in the common emitter of the paired transistor thereof a peak level of two inputs, Vₒ₊ and Vₒ₋.

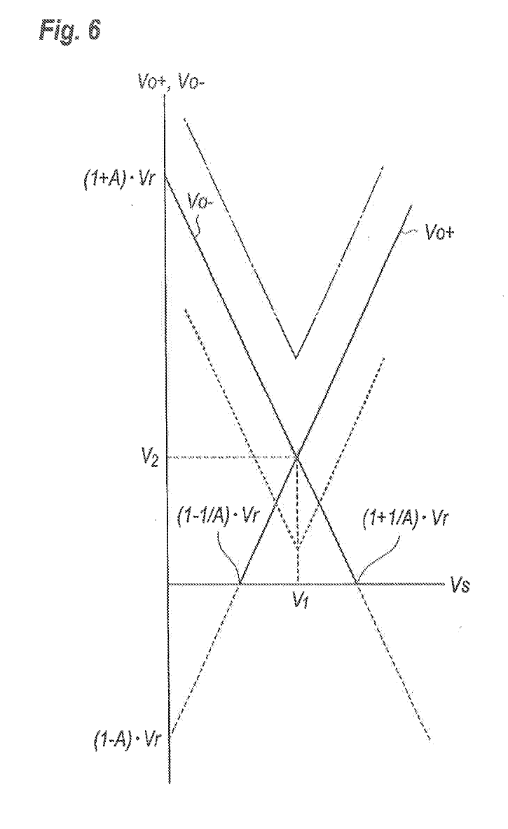

FIG. 6 schematically shows the relation between the sensing signal Vₛ and the power supply denoted by a chain line. The dotted line in FIG. 6 corresponds to the detected level of two outputs, Vₒ₊ and Vₒ₋, namely, the level of the common cathode in FIG. 5A or that of the common emitter in FIG. 5B. The detected level is lowered by the forward bias of a pn-junction, which is about 0.8V, of a diode. The DC/DC converter 35 may generate the power supply VCC raised by a voltage corresponding to the voltage source 37 from the detected level. The voltage of the voltage source 37 is preferably set to be a minimum bias between the drain and the source of the buffer FETs, 15A and 15B. When the voltage of the voltage source 37 becomes larger, the operation of two FETs, 15A and 15B, becomes stable but the power consumption. of the H-bridge inevitably increases.

The TEC-driver 1 thus described always monitors two outputs, Vₒ₊ and Vₒ₋, and adjusts the power supply VCC to be a value greater by the drain-source bias of the high side FETs, 15A and 15B, from the one of the outputs higher than the other. The H-bridge thus driven by the power supply VCC may save the power consumption as performing the analog operation.

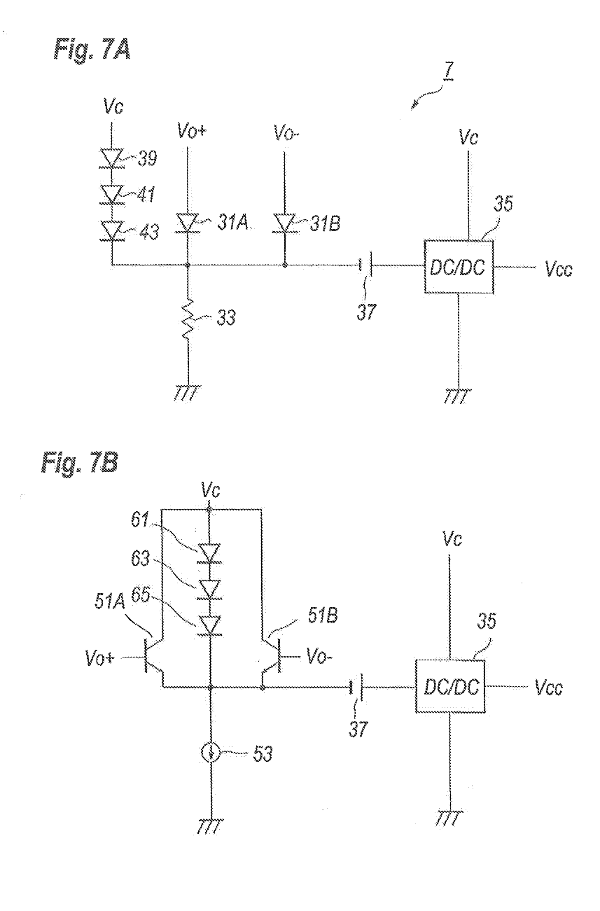

The present invention is not restricted to those aforementioned embodiments. For instance, the power supply 7 may have arrangements shown in FIGS. 7A and 7B. The power supply 7 shown in FIGS. 7A and 7B provides, in addition to those shown in FIGS. 5A and 5B, three diodes, 39 to 43 and 61 to 65, respectively. These diodes, which are connected in series between the primary power supply V_{c} and the detected level, namely, the common cathode in FIG. 7A, while, the common emitter in FIG. 7B, may cramp the detected level.

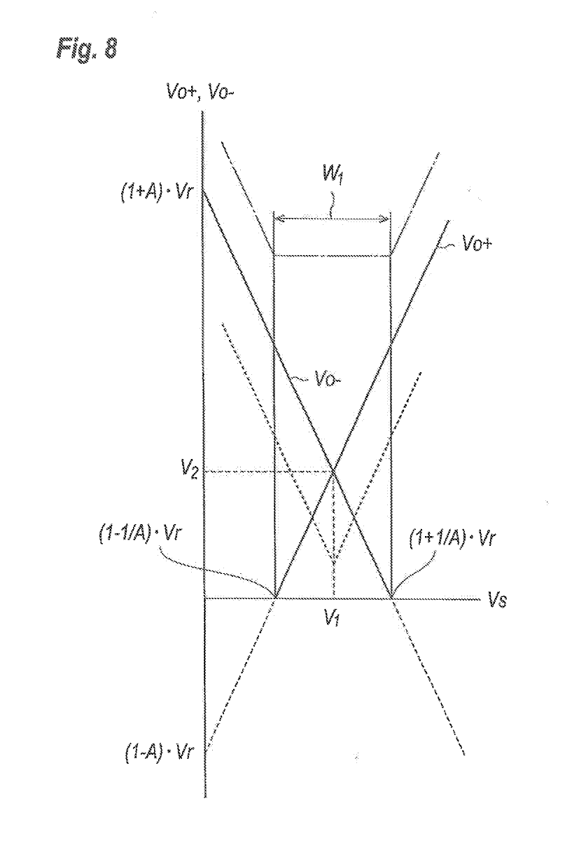

The power supply 7 shown in FIGS. 7A and 7B may stabilize the operation of the H-bridge. FIG. 8 shows a relation between the power supply VCC and the sensing signal Vₛ. When the sensing signal Vₛ is in the intermediate region W₁, (1−1/A)·Vᵣ<Vₛ<(1+1/A)·Vᵣ, the low side FETs, 5A and 5B, operate in the analog mode as already described. When the power supply VCC fully follows the decrease of the outputs, Vₒ₊ and Vₒ₋, the low side FETs, 5A and 5B, sometimes fails to operate in the analog mode. The modified power supply shown in FIGS. 7A or 7B has a function to maintain the voltage thereof in constant in the intermediate rang W1 independent of the decrease of the outputs, Vₒ₊ and Vₒ₋. Specifically, the detected level, namely, the level of the common cathode in FIG. 7A, or that of the common emitter in FIG. 7B, is cramped in a value of VC−m×V_{f}, where m is the number of diodes connected in series and V_{f} is the forward bias voltage of the diode. In a modification, the diodes connected in series may be replaced to a Zener diode.

Also, the voltage source 37 put between the detected level and the DC/DC converter 35 may he replaced to diodes connected in series. Setting the number of diodes and the forward bias of a diode are n and V_{f}, respectively, the DC/DC converter 35 outputs the power supply higher than the outputs, Vₒ₊ or Vₒ₋, by (n−1)×V_{f}. That is, a bias of (n−1)×V_{f} is applied between the drain and the source of the high side FETs, 15A and 15B. The diodes of the voltage source may be also replaced to a Zener diode.

While particular embodiments of the present invention have been described herein for purposes of illustration, many modifications and changes will become apparent to those skilled in the art. Accordingly, the appended claims are intended to encompass all such modifications and. changes as fall within the true spirit and scope of this invention.

What is claimed is:

1. A driver for driving a thermo-electric cooler (TEC) in an analog mode, comprising:
an H-bridge comprising a series circuit including a first transistor and a third transistor to generate a first output between the first and third transistors, another series circuit including a second transistor and a fourth transistor to generate a second output between the second and fourth transistors, the TEC being connected between the first output and the second output;
a power supply to generate a bias supplied to the H-bridge,
wherein the bias varies in accordance with one of the first output and the second output greater than the other.

2. The driver of claim 1,
wherein the first transistor and the fourth transistor are commonly driven by a first operational amplifier operating in a non-inverting mode for a sensing signal and a reference, and the second transistor and the third transistor are commonly driven by a second. operational amplifier operating in an inverting mode for the sensing signal and the reference,

3. The driver of claim 2,
wherein the first amplifier and the second amplifier have a gain A, and
wherein the H-bridge operates in the analog mode for a sensing signal in an intermediate region from (1−1/A)×Vr to (1+1/A)×Vr, where Vr is a reference level.

4. The driver of claim 2,
wherein the third transistor turns off when the sensing signal is greater than the intermediate range, and the fourth transistor turns off when the sensing signal is less than the intermediate range.

5. The driver of claim 1,
wherein the first transistor operates as a current buffer of the first operational amplifier and the second transistor operates as a current buffer for the second operational amplifier.

6. The driver of claim 5,
wherein the first operational amplifier accompanies with an input resistor put between the reference and an inverting input thereof, and a feedback resistor put between the first output and the inverting input, the first operational amplifier receiving the sensing signal in a non-inverting input and the reference through the input resistor accompanies with the first operational amplifier, and
wherein the second operational amplifier accompanies with an input resistor put between the sensing signal and an inverting input thereof, and a feedback resistor put between the second output and the inverting input thereof, the second operational amplifier receiving the sensing signal in the inverting input through the input resistor accompanies with the second operational amplifier and the reference in a non-inverting input thereof.

7. The driver of claim 1,
wherein the power supply includes a peak detector to detect one of a first level of the first output and a second level of the second output greater than the other, and
wherein the power supply sets the bias to be higher than the detected one of levels by a preset amount.

8. The driver of claim 7,
wherein the peak detector includes a first diode connected in an anode thereof to the first output and a second diode connected in anode thereof to the second output, the first diode and the second diode being commonly connected in cathodes thereof, and
wherein the one of the levels of the first and second outputs greater than the other is reflected in a level of the commonly connected anodes.

9. The driver of claim 7,
wherein the peak detector includes a first bipolar transistor connected in a base thereof to the first output and a second bipolar transistor connected in a base thereof to the second output, the first transistor and the second transistor being commonly connected in emitters thereof to a constant current source, and
wherein the one of the levels of the first and second outputs greater the other is reflected in a level of the commonly connected emitters.

10. The driver of claim 7,
wherein the preset amount corresponds to a bias where the first and second transistors linearly operate.

11. The driver of claim 3,
wherein the bias is set constant for the sensing signal in the intermediate region.

12. The driver of claim 11,
wherein the power supply includes a peak detector and a cramp circuit, the peak detector detecting one of a first level of the first output and a second level of the second output greater than the other, the cramp circuit cramping the one of the first level and the second level greater than the other, and
wherein the power supply sets the bias to be higher than the detected one of the levels by a preset amount out of the intermediate region.

13. The driver of claim 12,
wherein the peak detector includes a first diode connected in an anode thereof to the first output and a second diode connected in anode thereof to the second output, the first diode and the second diode being commonly connected in cathodes thereof,
wherein the cramp circuit is connected between the commonly connected cathodes and a primary power supply to cramp a level of the commonly connected cathodes, and
wherein the power supply generates the bias from the primary power supply in accordance with the level of the commonly connected cathodes.

14. The driver of claim 12,
wherein the peak detector includes a first bipolar transistor connected in a base thereof to the first output and a second bipolar transistor connected in a base thereof to the second output, the first transistor and the second transistor being commonly connected in emitters thereof to a constant current source,
wherein the cramp circuit is connected between the commonly connected emitters and a primary power supply to cramp a level of the commonly connected emitters, and
wherein the power supply generates the bias from the primary power supply in accordance with the level of the commonly connected emitters.

15. The driver of claim 12,
wherein the preset amount corresponds to a bias for the first and second transistors to operate linearly.

16. The driver of claim 12,
wherein the cramp circuit includes a plurality of diodes.

17. The driver of claim 12,
wherein the cramp circuit includes a zener diode.

18. The driver of claim 1,
wherein the first to fourth transistors are n-MOSFET.
